(19) United States
(12) Patent Application Publication
(10) Pub. No.: US 2006/0082311 A1
(43) Pub. Date: Apr. 20, 2006

(54) Ultrahigh pressure mercury lamp

(75) Inventor: Kensuke Fukushima, Himeji (JP)

Correspondence Address: ROBERTS, MLOTKOWSKI & HOBBES, P. O. BOX 10064, MCLEAN, VA, 22102-8064, US

(73) Assignee: Ushiodenki Kabushiki Kaisha, Tokyo (JP)

(21) Appl. No.: 11/244,289

(22) Filed: Oct. 6, 2005

(30) Foreign Application Priority Data
Oct. 14, 2004 (JP) 2004-300013

(51) Int. Cl. H01J 17/04; H01J 61/04

(52) U.S. Cl. 313/633

(57) ABSTRACT

To devise an ultrahigh pressure mercury lamp in which the disadvantages of formation of blackening and of cracks in the arc tube are reliably prevented, and it is possible even during operation over a long time to keep a high degree of maintenance of illuminance and reliability, the ultrahigh pressure mercury lamp has a pair of electrodes in the arc tube which is filled with at least 0.15 mg/mm³ of mercury and the electrodes have a carbon content that is at most 10 ppm by weight and an oxygen content that also is at most 10 ppm by weight.

### BACKGROUND OF THE INVENTION

1. Field of Invention

The invention relates to an ultrahigh pressure mercury lamp (hereinafter, also called only a “lamp”) which is used as a light source for backlighting, mainly of a liquid crystal projector and the like. The invention relates especially to an ultrahigh pressure mercury lamp in which the arc tube is filled with at least 0.15 mg/mm³ of mercury and in which the mercury vapor pressure during operation reaches at least 150 atm.

2. Description of Related Art

Recently, a projector device has drawn more and more attention in which images of a PC are projected onto a large screen in presentations, seminars, discussions, classroom instruction and the like. Depending on the image type, there are generally two types of projector devices, specifically, a liquid crystal type and a DLP (digital light processing type).

As the specification of a projector device, the liquid crystal type is most common in which liquid crystal cells with RGB (red-green-blue) are irradiated with light from a light source, and thus, images are projected. Many of the projector devices using the liquid crystal type are of the three-sheet type, in which cells with each color of RGB are used. In a projector device of the three sheet type, there is the advantage that the image resolution is high since the number of pixels is tripled.

The DLP type, conversely, is achieving more and more success, for example, in movie presentations. Its high image quality and high radiance are highly valued, for which reason, recently, the market has been expanding quickly. In the DLP type, DMD (digital micro mirror devices) chips in which a few hundred thousand to more than a million small mirrors are located next to one another on substrates are subjected to digital control, and thus, images are projected. The DLP type has higher radiance than the liquid crystal type. Furthermore, there is the advantage that the projector devices can be made smaller because a liquid crystal cell is not needed.

In the above described projector device, since illumination of the images uniformly with respect to the screen and also with sufficient color reproduction is necessary, a metal halide lamp which is filled with mercury and a halide is used as the light source. Since recently there has been a trend toward further increasing the radiance in the above described projector device, especially in a projector device of the DLP type, and making the device smaller and smaller, there is a great demand for increasing the radiance of the light source and reducing its size.

For this reason, recently, instead of a metal halide lamp, an ultrahigh pressure mercury lamp has been used more and more often as the light source of a projector device, with a mercury vapor pressure during operation which reaches at least 200 bar (roughly 197 atm). In this ultrahigh pressure mercury lamp, as shown in Japanese Patent Publication JP-A-2-148561 (which corresponds to U.S. Pat. No. 5,109,181) and Japanese Patent Publication JP-A-6-52830 (which corresponds to U.S. Pat. No. 5,497,049), there is a pair of electrodes in the arc tube which has a spherical light emitting part which is formed in the middle area, and hermetically sealed portions which are formed on opposite ends of this light emitting part. Metal foils are inserted into the hermetically sealed portions and hermetically sealed, and part of the respective electrode and the base of the electrode are connected to them. By using such an ultrahigh pressure mercury lamp, the broadening of the arc can be suppressed, and moreover, the light intensity can be increased even more by increasing the mercury vapor pressure during operation.

However, in an ultrahigh pressure mercury lamp, there is the disadvantage that, over the course of operation, the transmission factor of the arc tube drops, and thus, the degree of maintenance of the illuminance is greatly reduced. It is imagined that this reduction of the degree of maintenance of illuminance is caused mainly by the tungsten used as the electrode material, which vaporizes when the lamp is in operation, adhering to the inside wall of the arc tube, and thus, the arc tube becomes blackened. Therefore, as shown in Japanese Patent Publication JP-A-11-149899 (which corresponds to U.S. Pat. No. 6,211,616 B1) the adhesion of the tungsten to the inside wall of the arc tube can be suppressed using the halogen cycle with the halogen which is added to the arc tube.

Furthermore, in Japanese Patent Publication JP-A-2002-75269, the following is also proposed:

The arc tube is filled with a certain amount of oxygen;

A compound of tungsten which vaporizes and sprays off from the electrode, oxygen and a halogen is produced, and

the oxygen-halogen cycle is activated in which the compound which has been produced in this way is dissociated and tungsten is returned to the electrodes such that a high degree of maintenance of illuminance is obtained.

On the other hand, it has been proposed as a means for continuing the above described halogen cycle over a long interval, for example, in Japanese Patent Publication JP-A-2001-189146 (which corresponds to U.S. Pat. No. 6,844,679 B1), that halogen in a larger amount than the sum of the metallic elements of the impurities present in the emission space, such as sodium, potassium, lithium, chromium, iron and nickel, and tungsten which vaporizes during lamp operation off the electrodes, be added to the arc tube. The reason for this is the following:

If there are metallic impurities in the arc tube, the halogen reacts with the metallic impurities present in the emission space before a reaction with the tungsten which has vaporized off the electrodes. The ratio of the halogen which cannot contribute to the halogen cycle increases, by which the amount of halogen which is necessary to maintain the halogen cycle can no longer be ensured. The halogen cycle is then hindered, by which blackening of the arc tube is prevented.

However, even by the technology described in the aforementioned documents, it is not possible to adequately prevent tungsten electrode material from adhering to the inside wall of the arc tube in the course of operation, and thus, the arc tube from being blackened. Here, there was the disadvantage that it is difficult to ensure a high degree of maintenance of illuminance over a long time.

Furthermore, in an ultrahigh pressure mercury lamp there are cases in which bubbles remain in the hermetically sealed portions, that cracks form during operation at the locations at which the bubbles are present and that the disadvantage of leaking, breakage and the like occur. These cracks are caused by the bubbles which are produced by the impurities which adhere to the electrodes and the like and which are contained therein vaporizing in the lamp production steps and remaining in the gaseous state in the hermetically sealed portions. They arise specifically by a pressure distribution having formed in the hermetically sealed portions which have reached a high temperature by lamp operation, and by the pressure being concentrated especially at locations with low pressure tightness, such as locations at which the bubbles remain. However, this disadvantage is not mentioned in the above described publications.

### SUMMARY OF THE INVENTION

The primary object of the present invention is to devise an ultrahigh pressure mercury lamp in which, by reliably preventing the disadvantages of formation of blackening and of cracks in the arc tube, it is possible even during operation over a long time to keep a high degree of maintenance of illuminance, and which thus has high reliability.

(Prevention of Blackening)

To achieve the above described object, the inventor assiduously studied and observed that it is necessary not only to suppress the delivery of metallic impurities from the electrodes into the emission space, but also to suppress the delivery of the impurities contained in the electrodes, such as carbon and the like, into the emission space. It has been noted specifically that preventing the release of carbon into the emission space is effective to achieve the above described object, since by release of carbon into the emission space during lamp operation, oxygen and carbon which are necessary for the above described oxygen-halogen cycle react in the arc tube, produce CO, CO₂, H₂O and the like and that, therefore, the halogen cycle is prevented.

The inventor has furthermore found that a reduction in the amount of oxygen which is released into the emission space is effective. It is specifically necessary to reduce the amount of oxygen contained in the electrodes because, by emission of oxygen into the emission space during operation, diffusion of the carbon which is contained in the electrodes and which reaches a high temperature during operation is accelerated and release of carbon into the emission space is promoted, and furthermore, because in the emission space there is an unduly large amount of oxygen. This also causes destruction of the equilibrium of the oxygen-halogen cycle.

(By Way of Bubble Formation)

The inventor has conducted an analytic study of a lamp in which bubbles remained in the hermetically sealed portion, and he confirmed that there is a great probability that the main components of the impurity gases which form the bubbles are carbon and oxygen. It has been specifically found that a reduction in the contents of carbon and oxygen in the electrodes is effective for preventing bubble formation.

As was described above, the inventor found that a reduction in the amounts of carbon and oxygen which are contained in the electrodes of an ultrahigh pressure mercury lamp is extremely effective for prevention of blackening of the arc tube and cracking of the hermetically sealed portions. In this way, the inventor has completed the invention. In an ultrahigh pressure mercury lamp in which there is a pair of electrodes in the arc tube which is filled with at least 0.15 mg/mm³ of mercury, the invention is characterized in that the carbon content in the above described electrodes is at most 10 ppm by weight and the oxygen content is also at most 10 ppm by weight.

Action of the Invention

By the measure that, for the electrodes which are located in the arc tube, the carbon content is fixed at less than or equal to 10 ppm by weight, the ultrahigh pressure mercury lamp in accordance with the invention can prevent the carbon which is a factor for preventing the halogen cycle from being released into the emission space. Furthermore, by establishing the oxygen content at less than or equal to 10 ppm by weight, acceleration of the diffusion of the carbon in the electrodes is prevented even when the electrodes reach a high temperature state during lamp operation. Promotion of the release of the carbon from the electrodes is also prevented. Therefore, in the case of lamp operation over a long time, it is possible to reliably prevent the disadvantage that, in the course of operation, the arc tube is blackened. Furthermore, the ultrahigh pressure mercury lamp of the invention, by the measure that the content of carbon and oxygen, which are contained in the electrodes and which are the main cause of the disadvantage that in a conventional lamp in the hermetically sealed portions bubbles remain, is fixed at an extremely low value, the action can also be expected that, in the lamp production stages, no bubbles remain in the hermetically sealed portions. As a result, it is possible even in the case of operation over a long time to keep the degree of maintenance of the illuminance high. Therefore, an ultrahigh pressure mercury lamp with high reliability can be devised.

The invention is described in detail below with reference to the accompanying drawings.

### BRIEF DESCRIPTION OF THE DRAWINGS

FIG. 1 is a longitudinal cross-sectional view of an ultrahigh pressure mercury lamp in accordance the invention;

FIG. 2 is a plot of the temperature distribution of the cathode as a function of distance from the tip during lamp operation;

FIG. 3 is a plot of the temperature distribution of the anode as a function of distance from the tip during lamp operation;

FIG. 4(a) is an enlarged view of the cathode shown in FIG. 1, and

FIG. 4(b) is an enlarged view of the anode shown in FIG. 1.

### DETAILED DESCRIPTION OF THE INVENTION

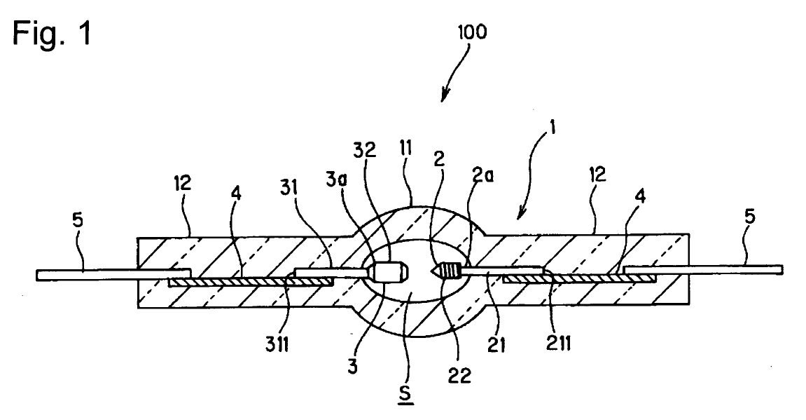

FIG. 1 shows an ultrahigh pressure mercury lamp 100 in accordance with the invention which has an arc tube 1, for example, of silica glass, with an essentially spherical light emitting part 11 and rod-shaped hermetically sealed portions 12 at opposite ends of the light emitting part 11. In the emission space S within the light emitting part 11, there are a cathode 2 and an anode 3 in opposed relation to each other. The cathode 2 comprises a rod component 21 of tungsten with a sharp tip and of a coil part 22 which has been formed by a wire material of tungsten having been wound around the rod component 21 in the vicinity of the tip. The anode 3 is formed of a tungsten rod component 31 and an enlarged diameter tungsten part 32 which is provided on the tip of the rod component 31. The enlarged diameter part 32 has an essentially cylindrical overall shape and on its front (side facing the cathode 2) and on its back (side directed toward a base 311), there is a tapering. The respective hermetically sealed portion 12 is hermetically sealed with a metal foil 4, which is made, for example, of molybdenum inserted for power supply.

The cathode 2, the base 211 of the rod component 31 or the base 311 are welded and electrically connected to one end of this metal foil 4. An outer lead 5 for power supply is welded and electrically connected to the other end of the metal foil 4 and extends to the outside from the hermetically sealed portion 12. A feed current source (not shown) is electrically connected to the outer lead 5 to power the ultrahigh pressure mercury lamp 100. The lamp 100 is operated using direct current.

The arc tube 1 is filled with mercury, halogen gas and a rare gas. The mercury is used to obtain the required wavelength of visible radiation, for example, to obtain radiant light with 360 nm to 780 nm, and at least 0.15 mg/mm³ is added, so that the mercury vapor pressure during operation is at least 150 atm. The amount of mercury can be suitably changed according to the desired mercury vapor pressure, it being different depending on the temperature conditions.

For example, roughly 13 kPa argon gas is added as the rare gas in order to improve the ignitability. Iodine, bromine, chlorine and the like in the form of a compound with mercury and another metal are added as the halogen. An amount of halogen is added in the range of 2×10⁻⁴ μm/mm³ to 7×10⁻³ micromole/mm³, for example, 5×10⁻⁴ μm/mm³. Its function is to prolong the service life using the halogen cycle. For an extremely small discharge lamp with an extremely high internal pressure, such as the discharge lamp in accordance with the invention, the main purpose is to prevent devitrification of the arc tube.

For the cathode 2 and the anode 3, both the content of carbon and also the oxygen content is at most 10 ppm by weight. Degassing is performed by the vacuum thermal treatment process described below. The cathode and the anode are subjected altogether to heat treatment at a high temperature in a vacuum atmosphere; this eliminates the carbon and the oxygen which are contained in the components of the tungsten of which the cathode and anode are made. Specifically, the treatment temperature is in the range from 1800° C. to 2300° C., for example, 2180° C., and the treatment time is in the range from 60 minutes to 180 minutes, for example, 120 minutes.

The numerical values of the above described ultrahigh pressure mercury lamp 10 are described below.

The maximum outside diameter of the light emitting part 11 is selected from the range from 9 mm to 13 mm and is, for example, 11.3 mm. The inside volume of the light emitting part 11 is in the range from 60 mm³ to 250 mm³, and is, for example, 116 mm³. The volume of the part 2a which is present in the emission space S of the cathode 2 is in the range from 1.5 mm³ to 10 mm³, and is, for example, 3.0 mm³. The volume of the part 3a which is present in the emission space S of the anode 3 is in the range from 5.5 mm³ to 50 mm³ and is, for example, 15 mm³. The distance between the electrodes is in the range from 0.9 mm to 1.6 mm and is, for example, 1.2 mm. The wall load is in the range from 0.8 W/mm² to 4 W/mm² and is for, example, 1.6 W/mm². The rated voltage is in the range from 55 V to 80 V and is 65 V. The rated wattage is in the range of 120 W to 350 W and is, for example, 200 W.

In the above described ultrahigh pressure mercury lamp of the invention, establishing the carbon content of the electrodes which are located in the arc tube to be at most 10 ppm by weight can prevent the carbon, which is a factor for preventing the halogen cycle, from being released into the emission space. Furthermore, fixing the oxygen content to be at most 10 ppm by weight, even when a high temperature state of the electrodes is reached during lamp operation, prevents acceleration of the diffusion of the carbon within the electrodes. Furthermore, this prevents the promotion of emission of carbon from the electrodes. Therefore, in the case of lamp operation over a long time, the disadvantage of blackening of the arc tube over the course of operation can be prevented.

Furthermore, the effect that, in the lamp production steps, no bubbles remain in the hermetically sealed portions can also be expected by the ultrahigh pressure mercury lamp of the invention by fixing the content of carbon and oxygen which are contained in a electrodes at a extremely low value, thereby addressing the main cause of the disadvantage that bubbles remain in the hermetically sealed portions in a conventional lamp.

Examples of experiments which were carried out to confirm the action of the invention are described below. The action of the invention is however not limited to the numerical values described below.

### EMBODIMENTS

According to the arrangement shown in FIG. 1, two ultrahigh pressure mercury lamps were produced with the content of carbon and oxygen contained in the electrodes (of cathode 2 and the anode 3) in the range of the invention indicated above. The arrangement of this ultrahigh pressure mercury lamp is described below.

The arc tube 1 was comprised a bulb of silica glass with a total length of 80 mm. The maximum outside diameter of the light emitting part 11 was 12.5 mm, the inside volume of the light emitting part 11 was 202 mm³ and the outside diameter of the hermetically sealed portion 12 was 6 mm.

The cathode 2 comprised a tungsten rod component having an outside diameter of 1.2 mm and a total length of 11 mm. The tip was tapered.

The rod component 31 of the anode 3 comprised a tungsten rod component with an outside diameter of 0.78 mm and a total length of 8.5 mm. The part 32 with an enlarged diameter comprises a cylindrical component of tungsten that was tapered at its front and back. The maximum outside diameter was 3 mm and the total length 5 mm.

The distance between the electrodes, specifically the cathode 2 and the anode 3, was 1.3 mm. The arc tube was filled with 41 mg of mercury, 5×10⁻⁴ μ/mm³ of bromine gas and 13.3 kPa of argon gas.

### COMPARISON EXAMPLES

Eight ultrahigh pressure mercury lamps were produced with the same arrangement as in the embodiments except that the content of carbon and oxygen which was contained in the electrodes (the cathode and anode) was not in the range used in accordance with the invention. All of the lamps were operated under the same operating conditions with a rated voltage of 70 V and a rated wattage of 275 W.

For each of the ultrahigh pressure mercury lamps as shown in the embodiments and the comparison examples, it was visually confirmed whether or not there were bubbles in the lamps directly after production, when they were not yet in operation. Furthermore, operation was repeated ten times, in which operation continued for two minutes and shut-off lasted 40 seconds. Thus, it was visually confirmed whether the arc tube was blackened or not. Additionally, the degree of maintenance of illuminance after 500 hours of uninterrupted operation of the lamps was confirmed.

In the column “presence or absence of blackening” in Table 1, “◯” means that no blackening at all was found, “o” means that hardly any blackening was found, “Δ” means that blackening was found only partially, and “x” means that blackening was found overall. In the column “presence or absence of bubbles” in Table 1, “o” means that no bubbles formed, “Δ” means that bubbles formed in part of the hermetically sealed portion, and “x” means that bubbles had formed in the entire hermetically sealed portion. In the column “degree of maintenance of illuminance” in Table 1, “o” means that the degree of maintenance of illuminance was greater than or equal to 80%, “Δ” means that it was in the range from 70% to 80%, and “x” means that it was either less than or equal to 70% or that the lamp was damaged.

The results of the tests are shown in Table 1.

TABLE 1

| | Carbon | Oxygen | | | |
|---|---|---|---|---|---|
| | content | content | Presence or | Presence or | Degree of |
| | (ppm by | (ppm by | absence of | absence of | maintenance of |
| | weight) | weight) | blackening | bubbles | illuminance |
| Embodiment 1 | 0.3 | 2.1 | ∘ | ∘ | ∘ |
| Embodiment 2 | 10.0 | 10.0 | ∘ | ∘ | ∘ |
| Comparison example 1 | 18.0 | 5.0 | Δ | Δ | Δ |
| Comparison example 2 | 30.0 | 5.0 | x | Δ | x |
| Comparison example 3 | 5.0 | 15.0 | ∘ | Δ | Δ |
| Comparison example 4 | 5.0 | 26.0 | ∘ | Δ | Δ |
| Comparison example 5 | 11.0 | 13.0 | ∘ | Δ | ∘ |
| Comparison example 6 | 18.0 | 22.0 | Δ | Δ | ∘ |
| Comparison example 7 | 30.0 | 45.0 | Δ | Δ | Δ |
| Comparison example 8 | 67.0 | 135.0 | x | x | x |

As shown in Table 1, in the ultrahigh pressure mercury lamps according to embodiments 1 and 2, in which the content of carbon and oxygen of the electrodes is in the range of the present invention, neither blackening of the arc tube nor bubble formation in the hermetically sealed portions occurred. Furthermore, after 500 hours of uninterrupted operation, a degree of maintenance of illuminance of at least 80% was ensured. Conversely, in ultrahigh pressure mercury lamps according to comparison examples 1 to 8 in which the content of carbon and oxygen of the electrodes is not in the range in accordance with the invention, blackening, bubble formation or both occurred. As a result, it was apparent that in some lamps the degree of maintenance of illuminance after 500 hours of uninterrupted operation dropped to less than 80%.

The inventors confirmed that, at an electrode temperature of at least 1600° C., the carbon and the oxygen which are contained in the electrodes are released into the emission space. In the course of lamp operation over a long time, there are also cases in which carbon and oxygen which are contained in the electrodes are released into the emission space by the high temperature state of the electrodes, that for this reason the amount of carbon and the amount of oxygen which are contained in the electrodes differ from the amount after production. In this case, there are cases in which, in the lamps after operation over a long time, it becomes difficult to ascertain whether or not they have the carbon and oxygen content in accordance with this invention.

Therefore, an attempt was made to check the process for reliable identification of lamps with the carbon and oxygen content in accordance with the invention. This process is described below.

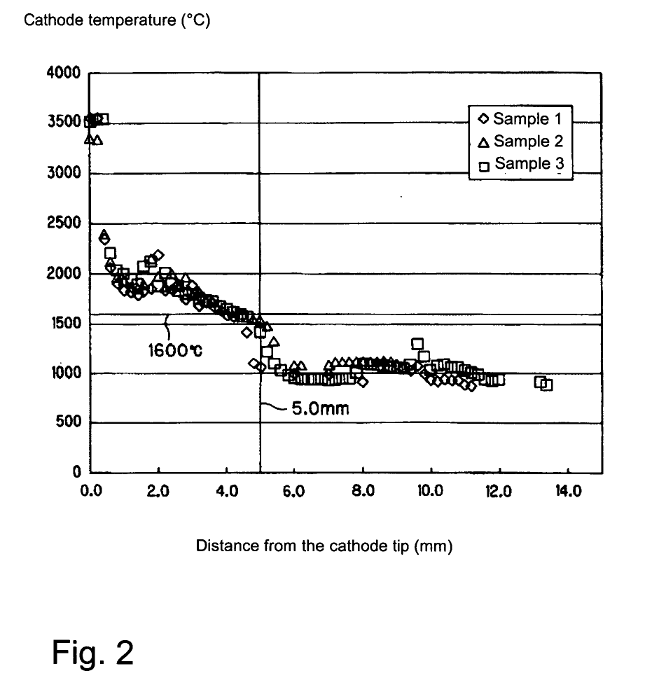

According to the arrangement shown in FIG. 1, three ultrahigh pressure mercury lamps were produced according to the specification which is shown below in Table 2 and were called specimens 1 to 3. They were each operated without interruption at an input of 250 W to 275 W. The result is shown in FIGS. 2 & 3.

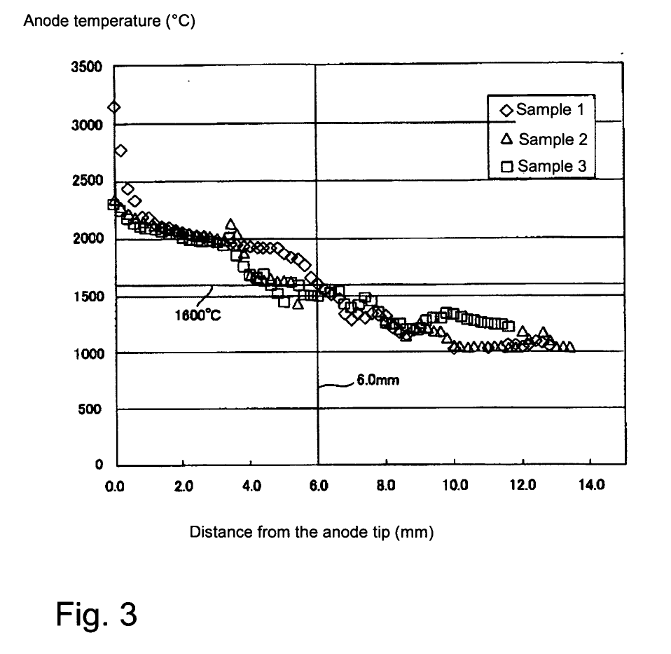

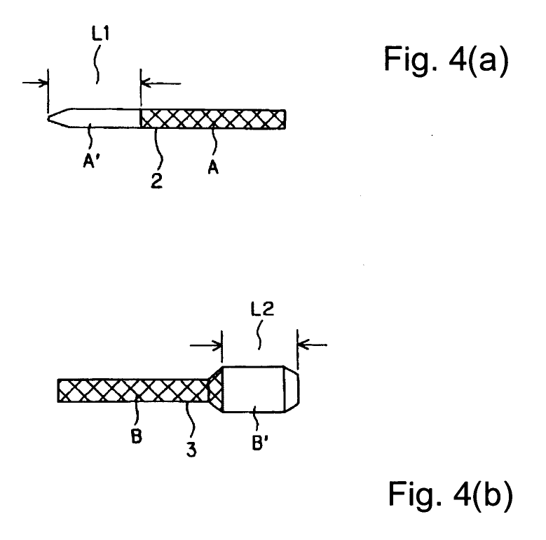

FIG. 2 is a plot of the temperature distribution of the cathode during lamp operation. Here, the y axis plots the temperature (° C.) and the x axis plots the distance (mm) from the cathode tip. FIG. 3 is a plot of the temperature distribution of the anode during lamp operation. Here, the y axis plots the temperature (° C.) and the x-axis plots the distance (mm) from the anode tip. FIG. 4(a) is an enlarged view of the cathode shown in FIG. 1 and FIG. 4(b) is an enlarged view of the anode shown in FIG. 1.

TABLE 2

| | | | | | Anode | | | |
|---|---|---|---|---|---|---|---|---|
| | Arc Tube | | Cathode | | Max. | Anode | Distance | Amount |
| | Outside | Inside | Outside | Total | outside | Total | between | of |
| | diameter | volume*1) | diameter | length | diameter | length | electrodes | mercury |
| | (mm) | (mm³) | (mm) | (mm) | (mm) | (mm) | (mm) | (mg) |
| Specimen 1 | 12.5 | 202 | 1.2 | 11 | 3 | 13.5 | 1.5 | 46 |
| Specimen 2 | 13 | 200 | 1.2 | 9.5 | 3 | 11 | 1.5 | 38 |
| Specimen 3 | 11.3 | 116 | 0.7 | 9.5 | 1.8 | 10.5 | 1.3 | 23 |

*1)Inside volume after sealing

As shown in FIG. 2, in the region A (FIG. 4(a)) in which the distance L1 from the cathode tip exceeds 5 mm, the temperature during lamp operation of all specimens is less than 1600° C. Therefore, the carbon gas or the like is prevented from being released into the emission space during operation. It can also be imagined that the carbon and oxygen content even after operation over a long time is equal to that directly after production. On the other hand, in the region A′ in which the distance from the cathode tip is less than 5 mm, depending on the lamp specification, the temperature during lamp operation exceeds 1600° C. Therefore, during operation, carbon gas and the like are released into the emission space during operation. It can be imagined that the content of carbon and oxygen after long operation is reduced as compared to that directly after production.

As FIG. 3 shows, in the region B (FIG. 4 (b)) in which the distance L2 from the anode tip exceeds 6 mm, the temperature during lamp operation of all specimens is less than 1600° C. Therefore the carbon gas or the like is prevented from being released into the emission space during operation. It can be imagined that the carbon and oxygen content even after operation over a long time is equal to that directly after production. On the other hand, it can be imagined that in the region B′ in which the distance from the anode tip is less than 6 mm, as in the cathode, after long operation, the content of carbon and oxygen is reduced as compared to that directly after production.

The results of the above described tests show that, to establish whether it is an ultrahigh pressure mercury lamp with the arrangement in accordance with the invention, it is sufficient to analyze the region A for the cathode and the region B for the anode which are locations which with respect to the carbon concentration and the oxygen concentration are not influenced by lamp operation, and to confirm the carbon concentration and the oxygen concentration. This means that when the carbon concentration in the regions A and B is at most 10 ppm and when the oxygen concentration is at most 10 ppm, it is an ultrahigh pressure mercury lamp with the arrangement in accordance with the invention.

Here, both the content of carbon and also the content of oxygen which are contained in the lamp electrodes were evaluated by a method which is called the combustion analysis process. Specifically, for the carbon portion, the specimens were heated in a high frequency furnace in an oxygen air flow together with a combustion aid, the CO portion and the CO₂ portion which are formed from the specimens were determined by IR radiation absorption, and based on the determination amounts thereof, the amount of carbon is quantitatively determined. For the oxygen portion, the specimens were heated in a graphite crucible and the resulting CO and CO₂ gases were subjected to flow limitation by He gas. The gas components were analyzed by a UV absorption process and the amounts of oxygen contained in the specimens were evaluated.

The invention is not limited to the above described embodiments, but various changes can also be made. In the above described embodiments, for example, ultrahigh pressure mercury lamps of the direct current operating type were described. However, the invention can also be used for ultrahigh pressure mercury lamps of the alternating current operating type.

What we claim is:

1. Ultrahigh pressure mercury lamp comprising a pair of electrodes in an arc tube which is filled with at least 0.15 mg/mm³ of mercury, wherein the electrodes have a carbon content of at most 10 ppm by weight and an oxygen content of at most 10 ppm by weight.

2. Ultrahigh pressure mercury lamp as claimed in claim 1, wherein the carbon content and the oxygen content of the electrodes are values determined at a location of the electrodes which reaches a temperature of less than 1600° C. during operation.

3. Ultrahigh pressure mercury lamp as claimed in claim 2, wherein the carbon content and the oxygen content of the cathode are values determined at a location which is more than 5 mm away from the tip of the cathode.

4. Ultrahigh pressure mercury lamp as claimed in claim 2, wherein the carbon content and the oxygen content of the anode are values determined at a location which is more than 6 mm away from the tip of the anode.
